(19) United States
(12) Patent Application Publication
(10) Pub. No.: US 2011/0150026 A1
(43) Pub. Date: Jun. 23, 2011

(54) SEMICONDUCTOR LASER PUMPED SOLID-STATE LASER DEVICE FOR ENGINE IGNITION

(75) Inventors: Masaki Tsunekane, Okazaki-shi (JP); Takunori Taira, Okazaki-shi (JP); Kenji Kanehara, Nishio (JP)

(73) Assignees: INTER-UNIVERSITY RESEARCH INSTITUTE CORPORATION, NATIONAL INSTITUTES OF NATURAL SCIENCES, Tokyo (JP); NIPPON SOKEN, INC., Nishio (JP)

(21) Appl. No.: 12/968,990

(22) Filed: Dec. 15, 2010

(30) Foreign Application Priority Data
Dec. 18, 2009 (JP) 2009-287546

(51) Int. Cl. H01S 3/094

(52) U.S. Cl. 372/75

(57) ABSTRACT

There is provided a semiconductor laser pumped solid-state laser device for engine ignition that can stably provide optical energy required for ignition across a wide temperature range. In the semiconductor laser pumped solid-state laser device for engine ignition, a plurality of semiconductor lasers 21, 22, 23, and 24 are used that have locking ranges, a temperature width thereof divided into a plurality of temperature ranges corresponding to a variation width of an ambient temperature, and that have the respective wavelengths falling within an absorption wavelength band of a solid-state laser medium 5 of the solid-state laser device in the temperature width of each locking range, to pump the solid-state laser medium 5 by multiplexing emitted lights from the plurality of semiconductor lasers 21, 22, 23, and 24 using a multiplexing mechanism to irradiate the solid-state laser medium 5.

### BACKGROUND OF THE INVENTION

1. Field of the Invention

The present invention relates to a semiconductor laser pumped solid-state laser device for engine ignition.

2. Description of the Related Art

A semiconductor laser pumped solid-state laser can absorb optical energy from a plurality of semiconductor lasers into a solid-state laser medium, followed by converting the energy to a highly focusing laser beam having a uniform electromagnetic wavefront in a solid-state laser resonator. Thus, the very high optical density can be obtained by focusing the laser beam using lenses. As such, this type of laser has been applied to a variety of common devices and systems, such as measuring light sources for physics and chemistry, as well as processing, e.g., cutting and welding, of various industrial materials.

Particularly, in consideration of global environment, such as the reduction in CO₂, researches have been focused on in recent years for the air-fuel mixture ignition in internal-combustion engines using laser beams having high peak intensity instead of sparking plugs. Since the laser ignition does not involve discharging metal electrodes, engine parts do not wear and thus their life can be enhanced. In addition, since ignition at an optimal position in a cylinder can be realized by changing a focusing position of the laser beam, the combustion efficiency and power of the engine is significantly improved and enhanced, allowing the reduction in the fuel consumption and also in the exhaust gas and CO₂. As described in Non-Patent Documents 1, 2, and 3 below, in combination with the innovatively improved performance of semiconductor laser pumped solid-state laser devices in recent years, laser devices have been downsized into sizes that are capable of being mounted in automobiles.

Moreover, devices have been proposed for engine ignition by directing a light from a laser source to an optical device through an optical fiber (see Patent Documents 1-3 below).
Patent Document 1: JP 2009-221895 A
Patent Document 2: JP 2007-107424 A
Patent Document 3: JP 2007-085350 A
Non-Patent Document 1: H. Kofler et al., “An innovative solid-state laser for engine ignition”, Laser Physics Letters, Vol. 4, No. 4, pp. 322-327 (2007)
Non-Patent Document 2: D. G. Rowe, “Lasers for engine ignition”, Nature Photonics, Vol. 2, No. 9, pp. 515-517 (2008)
Non-Patent Document 3: Masaki Tsunekane et al., “Micro-Lasers for Ignition Engines”, The Review of Laser Engineering, Vol. 37, No. 4, pp. 283-289 (2009)
Non-Patent Document 4: G. J. Steckman et al. “Volume Holographic Grating Wavelength Stabilized Laser Diodes”, IEEE Journal of Selected Topics in Quantum Electronics, Vol. 13, No. 3, pp. 672-678 (2007)
Non-Patent Document 5: Huikan Liu, Kevin J. Webb, “Bilayer Metamaterial Lens Breaks the Diffraction Limit”, Laser Focus World Japan, November 2009, pp. 40-42

Briefly, in order to install a semiconductor laser pumped solid-state laser device for ignition of an automobile engine in a vehicle, as shown in FIG. 17, the device is divided into a solid-state laser section and a pumping semiconductor laser section, and a solid-state laser ignition module 401 is disposed on an engine 402 while a pumping semiconductor laser module 403 under a passenger's seat, for example, both of which are then connected via an optical fiber 404. The reasons of arrangement in this manner include that the solid-state laser ignition module 401 itself has to be mounted directly on the engine 402 because the solid-state laser ignition module 401 emits a laser beam required for ignition having extremely high peak optical density, so that an optical fiber is subjected to an optical damage in the core thereof formed of quartz or the like and thus cannot propagate the laser beam, and that the pumping semiconductor laser module 403 is desirably installed in a position subjected to as less temperature change as possible instead of in the vicinity of the engine 402 involving substantial temperature change, because an oscillation wavelength thereof, which changes sensitively due to an environmental temperature, should be kept in an absorption wavelength band of a solid-state laser medium. Here, since a pumping light from the pumping semiconductor laser module 403 has low peak optical intensity, it can propagate to the solid-state laser using the optical fiber 404, as shown in FIG. 17. Although the pumping semiconductor laser module 403 needs to operate stably as a pumping light source within a relatively wide temperature range, specifically within a range of environmental temperature between −40 and 80 degrees C., in an environment which is always exposed to outside air, sunlight, wind, and rain, such as in an automobile, even if the pumping semiconductor laser module 403 is disposed in a position involving less temperature change as compared in the vicinity of the engine 402 as described above, a significant change in the environmental temperature causes the wavelength of the pumping semiconductor laser module 403 leaving the absorption wavelength band of the solid-state laser medium and the decrease in the amount of energy absorption in the solid-state laser ignition module 401, resulting in the possibility that a solid-state laser output required for engine 402 ignition cannot be obtained.

As a representative example of the semiconductor laser pumped solid-state laser, suppose the case where a semiconductor laser having an oscillation wavelength of 808 nm made of a mixed crystal, such as Al, Ga, In, As, and the like, is used to pump an YAG (yttrium aluminum garnet) solid-state laser medium containing Nd as an oscillating element (referred to as Nd:YAG). Although the temperature dependence of a wavelength of the semiconductor laser varies more or less due to the structure of a semiconductor material or an active layer, it is known generally that it changes approximately 0.3 nm per 1 degree C., as shown in FIG. 1. On the contrary, the absorption wavelength band of Nd:YAG varies less due to the temperature, which is in a range between 807 and 810 nm in the shown temperature range. Thus, when the ambient temperature of the semiconductor laser changes 10 degrees C. or more, the wavelength of the semiconductor laser leaves this absorption wavelength band.

In recent years, as novel techniques to lock the oscillation wavelength of the semiconductor laser in a specific wavelength and decrease an amount of wavelength change due to the temperature change, devices has been developed and commercialized that apply an optical combination of an inner semiconductor laser and an outer grating, or that apply a combination of an outer semiconductor laser and an inner grating also made of a semiconductor (distributed feedback laser: DFB) (see Non-Patent Document 4 above). While they are collectively referred to as a wavelength stabilized semiconductor laser, any of them has succeeded to lock the wavelength of the semiconductor laser by a portion of the light having a specified wavelength selected by the grating being fed back to a semiconductor laser resonator, so as to substantially restrain a change in the wavelength against the ambient temperature. In such a device, there exists a temperature range called a locking range, as shown in FIG. 2, in which the feedback from the grating effectively affects locking of the wavelength of the semiconductor laser. Although the locking range varies more or less due to the control wavelength as well as a semiconductor material or structure of an active layer, the maximum temperature width is presently approximately 30 degrees C., in which the wavelength change can be decreased to as less as 0.01 nm or less for 1 degree C. However, while the temperature dependence of the wavelength is very low within the locking range, the wavelength would change several nanometers at once at a boundary temperature where the locking becomes ineffective, so that the wavelength would change substantially away from the absorption wavelength band of the solid-state laser medium.

In view of the circumstances described above, the present invention is directed to provide a semiconductor laser pumped solid-state laser device for engine ignition that can stably supply optical energy required for ignition across a wide temperature range.

### SUMMARY OF THE INVENTION

In order to achieve the object described above, the present invention provides the following:

[1] A semiconductor laser pumped solid-state laser device for engine ignition wherein a plurality of semiconductor lasers are used that are locked within an absorption wavelength band of a solid-state laser medium, locking ranges thereof each having a different temperature range, and the overall locking range thereof completely covering a range of ambient temperature variation of the semiconductor lasers, to pump the solid-state laser medium by multiplexing emitted lights from the plurality of semiconductor lasers using a multiplexing mechanism to irradiate the solid-state laser medium.

[2] The semiconductor laser pumped solid-state laser device for engine ignition according to [1], wherein the multiplexing mechanism is configured of an optical fiber.

[3] The semiconductor laser pumped solid-state laser device for engine ignition according to [1], wherein the multiplexing mechanism is configured of a mirror.

[4] The semiconductor laser pumped solid-state laser device for engine ignition according to [1], wherein the multiplexing mechanism is configured of a lens formed of an anisotropic metamaterial.

[5] The semiconductor laser pumped solid-state laser device for engine ignition according to [1], wherein the wavelength of the semiconductor laser is stabilized using a grating.

[6] The semiconductor laser pumped solid-state laser device for engine ignition according to [1], wherein the locking ranges of the respective semiconductor lasers are overlapped with each other.

[7] A semiconductor laser pumped solid-state laser device for engine ignition provided with a temperature control mechanism for a semiconductor laser, wherein a plurality of preset temperatures are set within a locking range and a temperature control value is set to be one of the preset temperatures that most approximates an ambient temperature.

[8] The semiconductor laser pumped solid-state laser device for engine ignition according to [7], wherein the temperature control of the semiconductor laser is activated when a driver approaches a vehicle, a door on a driver's seat side is opened, a person sits on a driver's seat, or a main switch of the vehicle is turned ON.

[9] The semiconductor laser pumped solid-state laser device for engine ignition according to [7], wherein the semiconductor laser is enclosed by a heat insulator.

[10] The semiconductor laser pumped solid-state laser device for engine ignition according to [1], wherein a temperature controlling element is disposed in a semiconductor laser module.

[11] The semiconductor laser pumped solid-state laser device for engine ignition according to [10], wherein the temperature controlling element is a Peltier device.

[12] The semiconductor laser pumped solid-state laser device for engine ignition according to [10], wherein a grating-embedded semiconductor laser device is disposed in the semiconductor laser module.

[13] The semiconductor laser pumped solid-state laser device for engine ignition according to [1], wherein the plurality of semiconductor lasers are bonded to a member having high heat conductivity.

(A) According to the invention of claim 1, since an absorption wavelength of the solid-state laser can be stably emitted across a wide temperature range, stable ignition and combustion properties can be obtained in a broad environmental temperature range and any engine condition.

In addition, even with the semiconductor laser having a narrow locking range, the locking range can be widened by combining a plurality of semiconductor lasers.

Moreover, even if one of the semiconductor lasers fails or the output thereof becomes unstable, the engine can be driven by controlling the temperature within the locking range of the semiconductor laser that provides the stable output.

(B) According to the invention of claims 2 to 4, the pumping lights emitted from a plurality of semiconductor lasers can enter a single optical fiber. In the invention according to claim 3, a smaller area of the solid-state laser can be pumped by multiplexing the emitted lights from the semiconductor lasers using the mirror, resulting in the improvement in the oscillation efficiency of the solid-state laser.

In addition, a method using an anisotropic metamaterial according to claim 4 can significantly reduce the number of optics and decrease the optical losses as compared to other methods.

Particularly, the optics having a plurality of functions can be installed in a small space because the condenser lens and grating can be integrated, and the excellent vibration resistance can be achieved because misalignment is reduced. By using a bilayer lens adapting the anisotropic metamaterial, dispersion can be reduced and the light emitted from the semiconductor laser can be focused efficiently to the optical fiber.

(C) According to the invention of claim 5, the configuration is implemented wherein the grating is attached on an incident side or emitting side of the fiber for pumping light, or integrally with the condenser lens, so that the number of parts as well as the steps of alignment adjustment can be greatly reduced, resulting in the reduction in the cost and size.

(D) According to the invention of claim 6, the locking ranges are overlapped, so that a pumping wavelength can be stably emitted across an entire temperature range.

(E) According to the invention of claim 7, the optical energy required for ignition can be stably supplied across the wide temperature range.

(F) According to the invention of claim 8, the temperature of the semiconductor laser can be reliably controlled within a target temperature range before the engine is activated.

(G) According to the invention of claim 9, the energy required for the temperature control of the semiconductor laser can be minimized.

(H) According to the invention of claims 10 to 12, the Peltier device is disposed in the semiconductor laser module as the temperature controlling element, so that the temperature control of the semiconductor laser module can be performed accurately.

In addition, by reducing the heat capacity of the semiconductor laser device and the like on the Peltier device, the temperature response can be enhanced.

Moreover, in the invention according to claim 12, since the grating-embedded semiconductor laser device is disposed in the semiconductor laser module, a transmission grating is not required to be inserted in an optical path of the pumping light, and thus the device can be downsized.

(I) According to the invention of claim 13, a plurality of semiconductor lasers are bonded to the member having high heat conductivity, so that the heat efficiency of the temperature control can be enhanced.

### BRIEF DESCRIPTION OF THE DRAWINGS

FIG. 1 shows a relationship between an ambient temperature and wavelength of a conventional semiconductor laser without wavelength stabilization;

FIG. 2 shows a relationship between the ambient temperature and wavelength of a conventional wavelength stabilized semiconductor laser;

FIG. 3 shows a configuration of a solid-state laser device for engine ignition illustrating a first embodiment of the present invention;

FIG. 4 shows a relationship of the ambient temperature, wavelength, and locking range of each of four wavelength stabilized semiconductor lasers according to the first embodiment of the present invention;

FIG. 5 shows a configuration of the solid-state laser device for engine ignition illustrating a second embodiment of the present invention;

FIG. 6 shows a configuration of the solid-state laser device for engine ignition illustrating a third embodiment of the present invention;

FIG. 7 shows a configuration of the solid-state laser device for engine ignition illustrating a fourth embodiment of the present invention;

FIG. 8 shows a configuration of the solid-state laser device for engine ignition illustrating a fifth embodiment of the present invention;

FIG. 9 shows a first configuration of an end of an optical fiber of the solid-state laser device in FIG. 8;

FIG. 10 shows a second configuration of the end of the optical fiber of the solid-state laser device in FIG. 8;

FIG. 11 shows a configuration of the solid-state laser device for engine ignition illustrating a sixth embodiment of the present invention;

FIG. 12 shows a configuration of the solid-state laser device for engine ignition illustrating a seventh embodiment of the present invention;

FIG. 13 shows a configuration of a semiconductor laser module having high temperature response illustrating an eighth embodiment of the present invention;

FIG. 14 shows a configuration of the semiconductor laser module having high temperature response when using a grating-embedded wavelength stabilized semiconductor laser, illustrating a ninth embodiment of the present invention;

FIG. 15 shows specific procedure for controlling the semiconductor laser pumped solid-state laser device for engine ignition according to the present invention;

FIG. 16 shows a relationship between the ambient temperature of the semiconductor laser pumped solid-state laser device for engine ignition and a preset temperature of the semiconductor laser to be controlled, according to the present invention; and

FIG. 17 shows an arrangement of the solid-state laser device for engine ignition in an automobile.

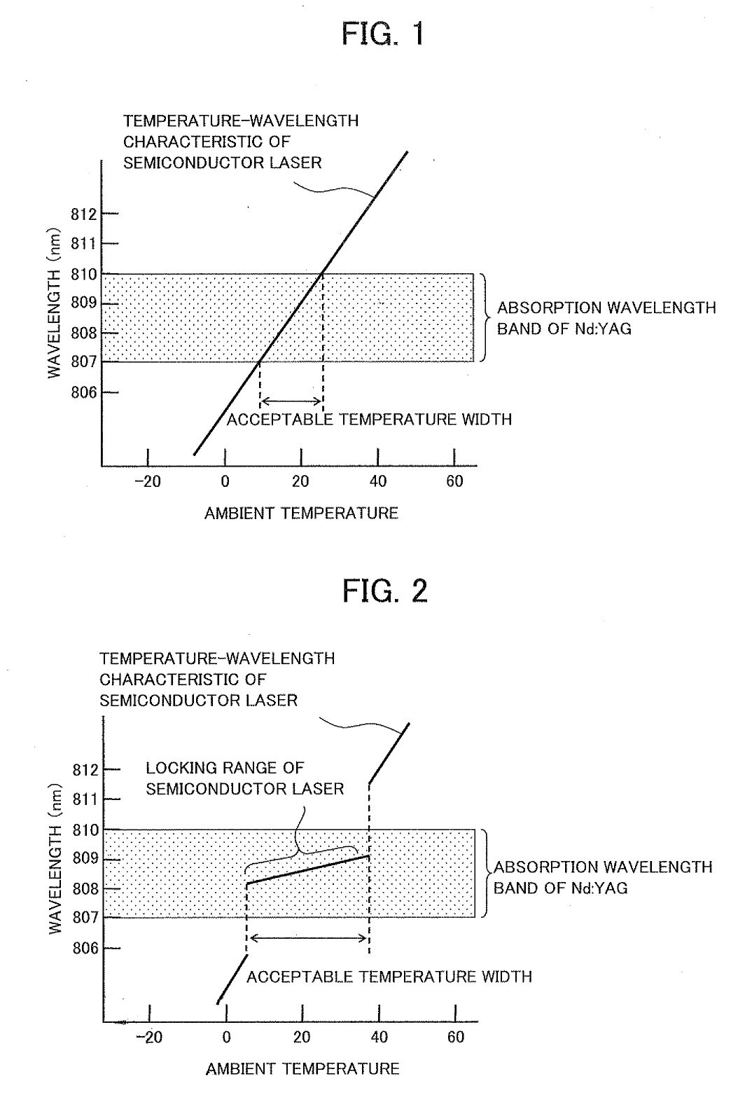

### DESCRIPTION OF THE PREFERRED EMBODIMENTS

A semiconductor laser pumped solid-state laser device for engine ignition according to the present invention uses a plurality of semiconductor lasers that are locked within an absorption wavelength band of a solid-state laser medium, locking ranges thereof each having a different temperature range, and the overall locking range thereof completely covering a range of ambient temperature variation of the semiconductor lasers, to pump the solid-state laser medium by multiplexing emitted lights from the plurality of semiconductor lasers using a multiplexing mechanism to irradiate the solid-state laser medium.

### Embodiments

Hereinafter, the embodiments of the present invention will be described in detail.

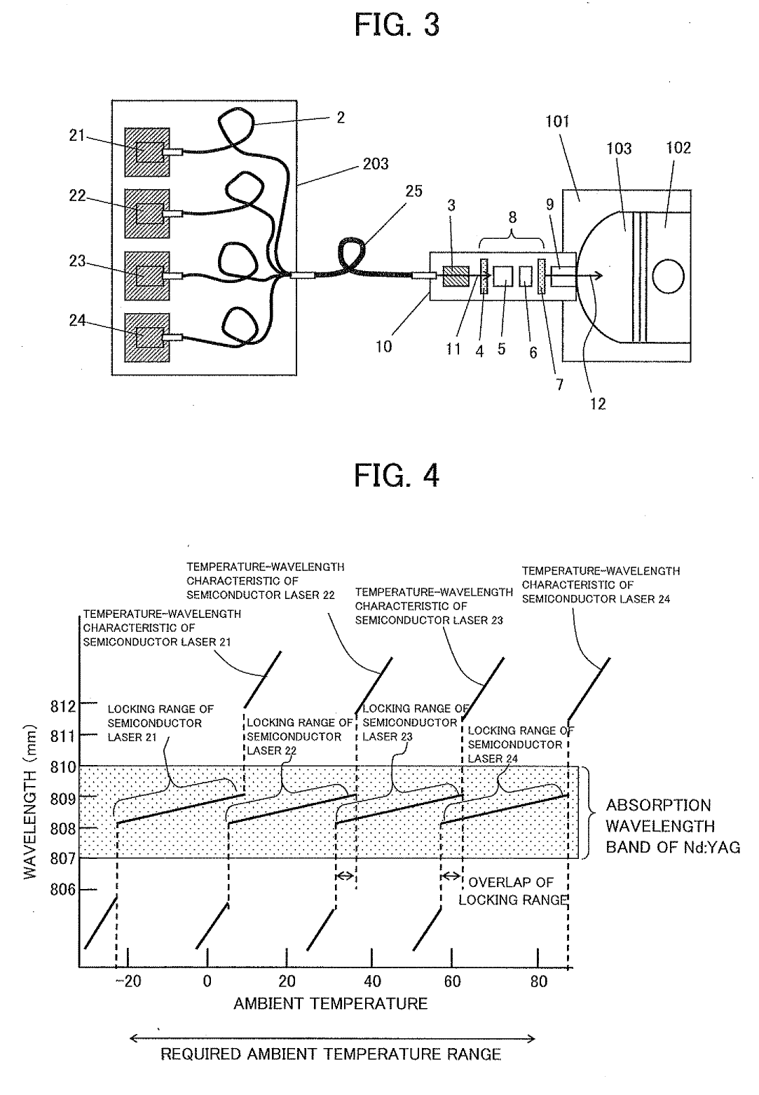

FIG. 3 shows a configuration of a solid-state laser device for engine ignition illustrating a first embodiment of the present invention.

In this figure, when there are provided four wavelength stabilized semiconductor lasers 21-24 as a pumping semiconductor laser module 203, for example, pumping lights emitted from these wavelength stabilized semiconductor lasers 21-24 propagate through each multi-mode optical fiber 2 with 200 μm in core diameter to irradiate a solid-state laser medium 5 in a solid-state laser module 10. In this regard, an optical fiber bundle 25 having the cores of the respective optical fibers 2 bundled together is used upstream of the solid-state laser module 10. By converging the lights from the respective wavelength stabilized semiconductor lasers 21-24 into the single optical fiber bundle 25, the pumping light can be introduced into the solid-state laser medium 5 through spatial propagation by a single common pumping optical system 3 in the solid-state laser module 10. The pumping light spontaneously generates a short-pulsed laser beam having high peak intensity by a laser oscillator 8 (a pump mirror 4, the solid-state laser medium 5, an optical switch element 6, and an output mirror 7) provided in the solid-state laser module 10. The generated laser beam 12 is focused on a given spatial position in a combustion chamber 103 through a focusing optical system 9 configured of lenses to ignite a combustible air-fuel mixture in the combustion chamber 103. In this figure, reference numeral 101 denotes a cylinder, and 102 denotes a piston.

Here, the pump mirror 4 is a plane mirror made from BK7, having the surface facing the pumping semiconductor laser module 203 coated with a non-reflection coating (reflectivity<0.2%) for a pumping light wavelength 808 nm, and the surface facing the solid-state laser medium 5 coated with a total reflection coating (reflectivity>99.7%) for a solid-state laser oscillation light wavelength 1064 nm and a low reflection coating (reflectivity<2%) for the pumping light wavelength 808 nm. As the solid-state laser medium 5, Nd:YAG is used containing Nd (neodymium) as a laser oscillation element and YAG (yttrium aluminum garnet) as a base material. The doping concentration of Nd is 1.1 at %, and the length of the medium is 5 mm. In addition, as the optical switch element 6, YAG doped with tetravalent Cr (chromium) as a saturable absorber (Cr:YAG) is used. The initial transmittance of Cr:YAG in the oscillation wavelength of the solid-state laser is 30%. Both end surfaces of the solid-state laser medium 5 and the optical switch element 6 are coated with a non-reflection coating (reflectivity<0.2%) for the solid-state laser oscillation light wavelength 1064 nm. The output mirror 7 is a plane mirror made from BK7, and coated with a coating having 50% reflectivity for the solid-state laser oscillation light wavelength 1064 nm.

Four wavelength stabilized semiconductor lasers 21-24 used for pumping are repeatedly and intermittently driven by a pulsed current having 500 μs in interval length and 5-100 Hz in frequency. The peaking capacity of the optical output from the respective wavelength stabilized semiconductor lasers 21-24 is 120 W each, which is sufficient as the pumping energy for laser ignition by the solid-state laser.

The wavelength stabilized semiconductor lasers 21-24 each includes a transmission grating interposed between a semiconductor laser device and the optical fiber 2, so that a portion of the pumping light having specific wavelengths emitted from the semiconductor laser device is fed back to the semiconductor laser device to stabilize the wavelength. An interval and angle of the grating are adjusted so that all the wavelengths fed back to the wavelength stabilized semiconductor lasers 21-24 would approximate the peak of the absorption wavelength band, 809 nm, of the solid-state laser medium 5 formed of Nd:YAG.

FIG. 4 shows a relationship of the ambient temperature, wavelength, and locking range of each of four wavelength stabilized semiconductor lasers according to the first embodiment of the present invention.

In this figure, locking ranges of the semiconductor lasers 21-24 used are from −20 to 10, 5 to 35, 30 to 60, and 55 to 85 degrees C., respectively. With this configuration, even in the case where the ambient temperature of the pumping semiconductor laser module 203 varies between −20 and 80 degrees C., at least one of the wavelength stabilized semiconductor lasers consistently remains within the locking range and operates in the proximity of the wavelength 809 nm, and thus the solid-state laser medium 5 can consistently absorb the pumping energy 120 W required for oscillation to output the optical energy required for ignition.

In this semiconductor laser pumping solid-state laser device, one of the wavelength stabilized semiconductor lasers can supply sufficient energy as long as the wavelength remains within the absorption wavelength band of the solid-state laser medium 5. Accordingly, it is not required to consistently drive all the wavelength stabilized semiconductor lasers for ignition, and it is sufficient instead to monitor the ambient temperature around the semiconductor lasers and drive only one of them having the locking range adapted to the monitored temperature.

In addition, in this embodiment, since the wavelengths of the wavelength stabilized semiconductor lasers become unstable at the boundaries of the locking ranges, the locking ranges of the adjacent wavelength stabilized semiconductor lasers are overlapped with each other for approximately 5 degrees C. Giving 2.5-degree C. margins for switching the wavelength stabilized semiconductor lasers to be driven allows stable operation and energy absorption into the solid-state laser medium across all the temperature ranges.

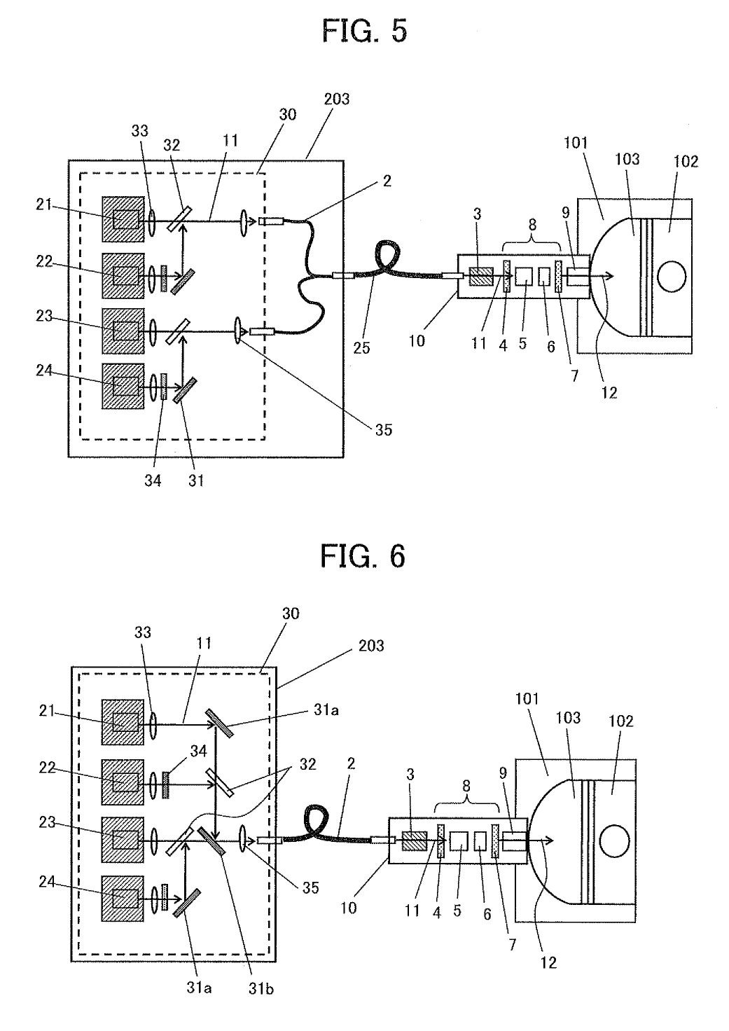

FIG. 5 shows a configuration of the solid-state laser device for engine ignition illustrating a second embodiment of the present invention.

In this embodiment, a manner to converge pumping lights 11 from the wavelength stabilized semiconductor lasers 21-24 is such that the lights from two wavelength stabilized semiconductor lasers 22, 24 in the pumping semiconductor laser module 203 are polarized by 90 degrees using half-wave plates 34, multiplexed respectively with the lights from the wavelength stabilized semiconductor lasers 21, 23, and then introduced into the optical fiber 2. In this figure, reference numeral 30 denotes a spatial multiplexing chamber for laser beam, 31 denotes a 45-degree total reflection mirror, 32 denotes a polarizing mirror, 33 denotes a collimating optical system, and 35 denotes a condenser lens.

With this configuration, the number of the optical fiber cores in the optical fiber bundle 25 is reduced to half, resulting in the reduction in the core diameter of bundled fibers as well as the improvement in the pumping of a smaller area of the solid-state laser and in the oscillation efficiency of the solid-state laser.

FIG. 6 shows a configuration of the solid-state laser device for engine ignition illustrating a third embodiment of the present invention.

In this embodiment, a manner to converge the pumping lights 11 from the wavelength stabilized semiconductor lasers 21-24 is such that the lights from two wavelength stabilized semiconductor lasers 22, 24 in the pumping semiconductor laser module 203 are polarized by 90 degrees using the half-wave plates 34, multiplexed respectively with the lights from the wavelength stabilized semiconductor lasers 22, 24, then the optical system is electrically switched using a retractable mirror 31b, only the light from the wavelength stabilized semiconductor laser within the locking range selected depending on the environmental temperature, and the pumping light is introduced into the solid-state laser module 10 using the optical fiber 2 having a single core. Since the optical fiber bundle is not required while the retractable mirror 31b needs to be controlled here, the optical fiber can be structurally simplified without the need of the optical fiber module and the fiber core diameter can be reduced more, resulting in the improvement in the pumping of a smaller area of the solid-state laser and in the oscillation efficiency of the solid state laser. Here, reference numeral 31a denotes a 45-degree total reflection mirror.

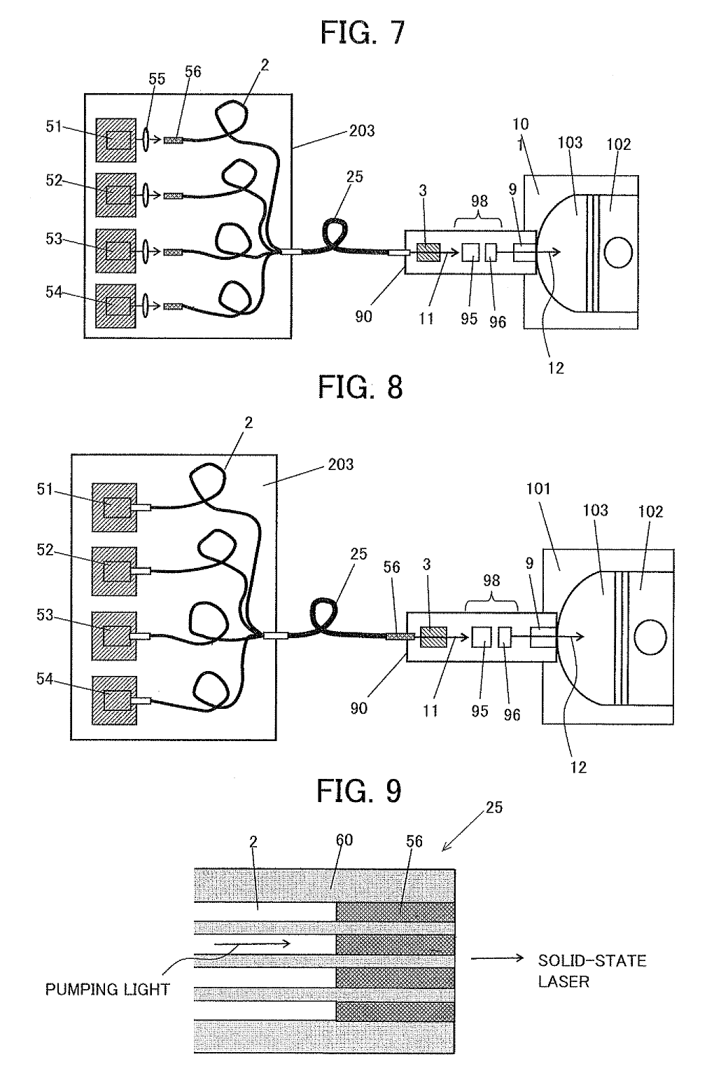

FIG. 7 shows a configuration of the solid-state laser device for engine ignition illustrating a fourth embodiment of the present invention.

In this embodiment, semiconductor lasers 51-54 in the pumping semiconductor laser module 203 do not have a structure for wavelength stabilization by the grating or the like. Each pumping light emitted from the respective semiconductor lasers 51-54 propagates spatially and enters an optical fiber grating 56 attached to the end of each optical fiber 2. A grating interval of the optical fiber grating 56 is set so as to partially reflect the light having the wavelength of 809 nm selectively. The reflected lights return to the semiconductor lasers 51-54, and the oscillation wavelength of the respective semiconductor lasers 51-54 can be controlled (locked). Here, reference numeral 55 denotes a condenser lens.

A solid-state laser module 90 in this embodiment does not include the pump mirror and output mirror, while the end surface facing the pumping side of a solid-state laser medium 95 formed of Nd:YAG, as with the first to third embodiments described above, is coated with a full reflection coating (reflectivity>99.7%) for the solid-state laser oscillation light wavelength 1064 nm and with a low reflection coating (reflectivity<2%) for the pumping light wavelength 808 nm, and the end surface thereof facing an optical switch element 96 is coated with a non-reflection coating (reflectivity<0.2%) for the solid-state laser oscillation light wavelength 1064 nm. Similarly, the end surface facing the solid-state laser medium 95 of the optical switch element 96 formed of Cr:YAG is coated with a non-reflection coating (reflectivity<0.2%) for the solid-state laser oscillation light wavelength 1064 nm, and the end surface thereof facing the cylinder 101 is coated with a coating having 50% reflectivity for the solid-state laser oscillation light wavelength 1064 nm. By forming resonator mirrors by the coatings applied on the end surfaces of the solid-state laser medium 95 and the optical switch element 96, the pump mirror and output mirror can be omitted, resulting in the reduction in the number of parts, the miniaturization of a resonator, and the improvement in the reliability against vibration or the like.

These semiconductor lasers 51-54 have centers of the oscillation wavelengths offset by 7.5 nm from each other at the same temperature: at 20 degrees C., the semiconductor laser 52 exhibits the center wavelength of 809 nm, the semiconductor laser 51 exhibits 816.5 nm, the semiconductor laser 53 exhibits 801.5 nm, and the semiconductor laser 54 exhibits 794 nm. The peaking capacity of each semiconductor laser device is 120 W. In this manner, by using the semiconductor lasers 51-54 having different center wavelengths, the respective semiconductor lasers 51-54 can be provided with the same wavelength stabilization and its temperature dependence as that of the configuration of the first embodiment described above. By utilizing the optical fiber grating 56 on the input ends of the optical fibers for wavelength stabilization of each semiconductor laser, the number of component parts can be reduced and thus manufacture and alignment can be facilitated.

FIG. 8 shows a configuration of the solid-state laser device for engine ignition illustrating a fifth embodiment of the present invention.

In this embodiment, the configuration of the semiconductor lasers is similar to that of the fourth embodiment described above, except that the optical fiber grating 56 is provided adjacent to the end surface of the optical fiber bundle 25 on the solid-state laser medium side, not providing on the semiconductor laser side.

FIG. 9 shows a first configuration of the end of the optical fiber of the solid-state laser device in FIG. 8. As shown in this figure, if the gratings can be formed collectively on the end surface of the optical fiber bundle 25, the manufacture can be facilitated, resulting in the reduction in the cost. Here, reference numeral 60 denotes an optical fiber sheath.

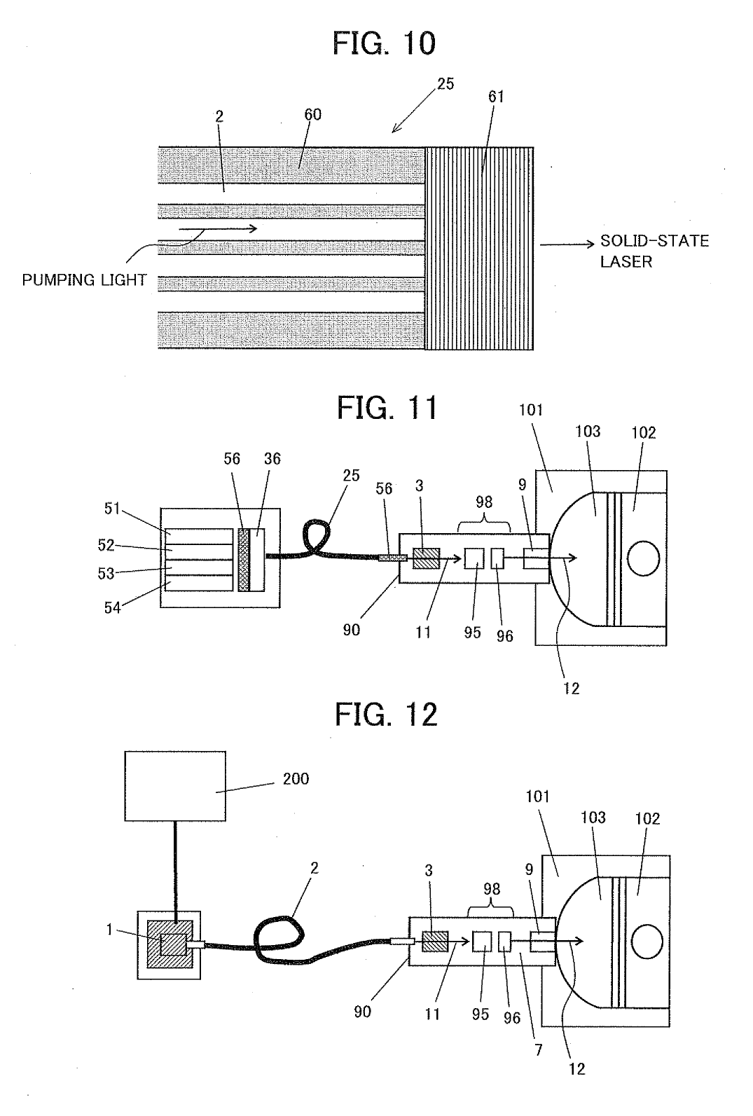

FIG. 10 shows a second configuration of the end of the optical fiber of the solid-state laser device in FIG. 8, wherein a transmission grating 61, instead of the optical fiber grating 56 in FIG. 9, is formed in the proximity of the end surface of the optical fiber bundle 25. Since the single transmission grating 61 can give a feedback of the 809-nm light to all the semiconductor lasers 51-54 through the optical fiber 2 to lock the wavelength, the structure can be simplified as compared to forming of the optical fiber grating respectively and thus the cost can be reduced. Moreover, by providing the grating 61 adjacent to the end surface of the optical fiber bundle 25, the light can be fed back without interposing the optical system. The transmission grating 61 may be adhered or bonded to the optical fiber end.

FIG. 11 shows a configuration of the solid-state laser device for engine ignition illustrating a sixth embodiment of the present invention.

While a multiplexing mechanism of the pumping lights from a plurality of semiconductor lasers can be configured of the optical fibers or mirrors as described in the above embodiments, a bilayer lens 36 formed of an anisotropic metamaterial is used in this embodiment (see Non-Patent Document 5 above). Although any conventional lens is subjected to Abbe's diffraction limit regardless of a numerical aperture thereof, the “superlens” has been proposed recently which can form an image beyond Abbe's diffraction limit based on the notion of a negative refractive index. The superlens includes an optical anisotropic metamaterial for subwavelength imaging having low losses and wider bandwidths. This anisotropic metamaterial allows subwavelength imaging when an evanescent wave having a large transverse wavelength enters to be converted to a propagation wave in the medium. By using such an anisotropic metamaterial for the multiplexing mechanism of the pumping lights from a plurality of semiconductor lasers, the condenser lens and grating can be integrated, resulting in the reduction in the cost of the optics.

In the embodiments described above, the base material of the solid laser medium may include YVO₄, YLF, GdVO₄, Al₂O₃, KGW, KYW, and glass. Also, the laser oscillation element may include Yb, Ho, Tm, Ti, and Er. In addition, the material and oscillation wavelength of the pumping semiconductor laser are selected to adapt to the absorption wavelength band of the solid-state laser medium to be used. The material and specification of the optical switch element are also suitably selected depending on the solid-state laser medium. Moreover, while four wavelength stabilized semiconductor lasers are used in the first to sixth embodiments described above, the requirement for the number and the specification of wavelength width of the semiconductor lasers is determined based on the absorption wavelength width of the solid-state laser medium to be used, an amount of change in the ambient temperature, the locking ranges of the semiconductor lasers to be used, and the like.

The embodiments described above provides a substantial advantage that the pumping optical energy having a desired wavelength can be supplied immediately to the solid-state laser at any assumed environmental temperature, involving no or simple temperature control of the semiconductor lasers. However, if the semiconductor lasers to be used have narrow locking ranges and the solid-state laser medium to be used have a narrow absorption wavelength width, a plurality of semiconductor lasers having different locking ranges have to be selected and prepared, resulting in increase in cost. There is also a disadvantage that the size increases due to multiple semiconductor lasers being used.

In view of the above, a seventh embodiment below uses single wavelength stabilized semiconductor laser provided with a temperature regulation function to provide a method of controlling thereof in order to operate efficiently as a vehicle-mounted type and a structure of the semiconductor laser which is less effected by the change in the ambient temperature.

FIG. 12 shows a configuration of the solid-state laser device for engine ignition illustrating the seventh embodiment of the present invention.

In this figure, a wavelength stabilized semiconductor laser 1 is temperature-controlled by a temperature control unit 200, and the pumping light is introduced into the solid-state laser module 90 through the optical fiber 2.

The pumping light 11 emitted from the optical fiber 2 is shaped by the pumping optical system 3, irradiated to the solid-state laser medium 95, and absorbed therein. The pumping light spontaneously generates the short-pulsed laser beam having high peak intensity by a laser oscillator 98 provided in the solid-state laser module 90. A generated laser beam 12 is focused on a given spatial position in the combustion chamber 103 through the focusing optical system 9 configured of lenses to ignite the combustible air-fuel mixture in the combustion chamber 103. Here, the configuration of the solid-state laser module 90 is the same as that of the fourth embodiment.

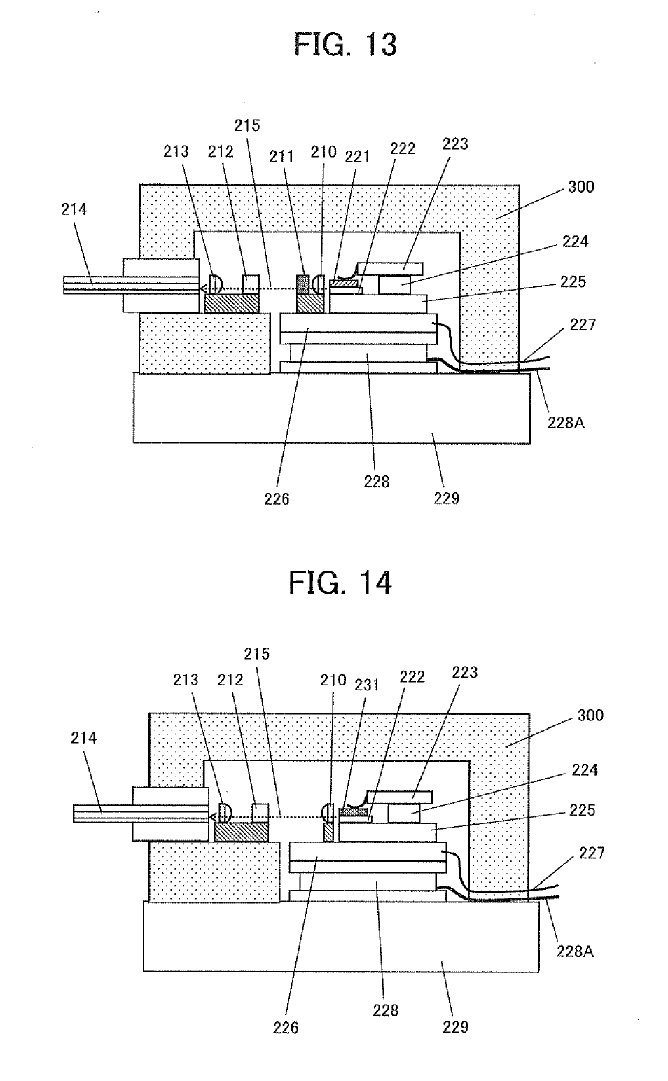

FIG. 13 shows a configuration of a semiconductor laser module having high temperature response illustrating an eighth embodiment of the present invention.

In this figure, there are shown a Peltier device 228 as a temperature controlling element (TE (thermo-electric) cooling element) to control the temperature, a base metal 226 disposed thereon, a heat sink (metal) 225 disposed thereon, and a semiconductor laser device 221 and a submount 222, as well as an electrode 223 connected to the semiconductor laser device 221 via an insulator 224, disposed thereon. In addition, a collimating microlens 210 and a transmission grating 221 for wavelength control are disposed to adjust an optical axis of a pumping light 215 emitted from the semiconductor laser device 221. Any other optics is not disposed on the Peltier device 228.

FIG. 14 shows a configuration of the semiconductor laser module having high temperature response when using a grating-embedded wavelength stabilized semiconductor laser, illustrating a ninth embodiment of the present invention.

The configuration is the same as that in FIG. 13 except that the transmission grating 211 is not required to be inserted in an optical path of the pumping light 215, as with the eighth embodiment, by using a grating-embedded semiconductor laser device 231.

In these eighth and ninth embodiments, the temperature response is enhanced by decreasing heat capacity of the semiconductor laser device and the like on the Peltier device 228. In addition, the wavelength stability of the semiconductor laser devices 221, 231 against the change in the ambient temperature is enhanced by disposing a heat insulator 300 around the outer wall of the module so as to enclose the semiconductor laser device. The heat insulator 300 includes amorphous silica, hard urethane, vacuum heat insulator, and the like. Here, reference numeral 212 denotes a collimating microlens, 213 denotes a condenser lens, 214 denotes an optical fiber, 227 denotes a lead wire connected to a temperature sensor, 228A denotes a lead wire connected to a temperature control unit (not shown), and 229 denotes a metal base.

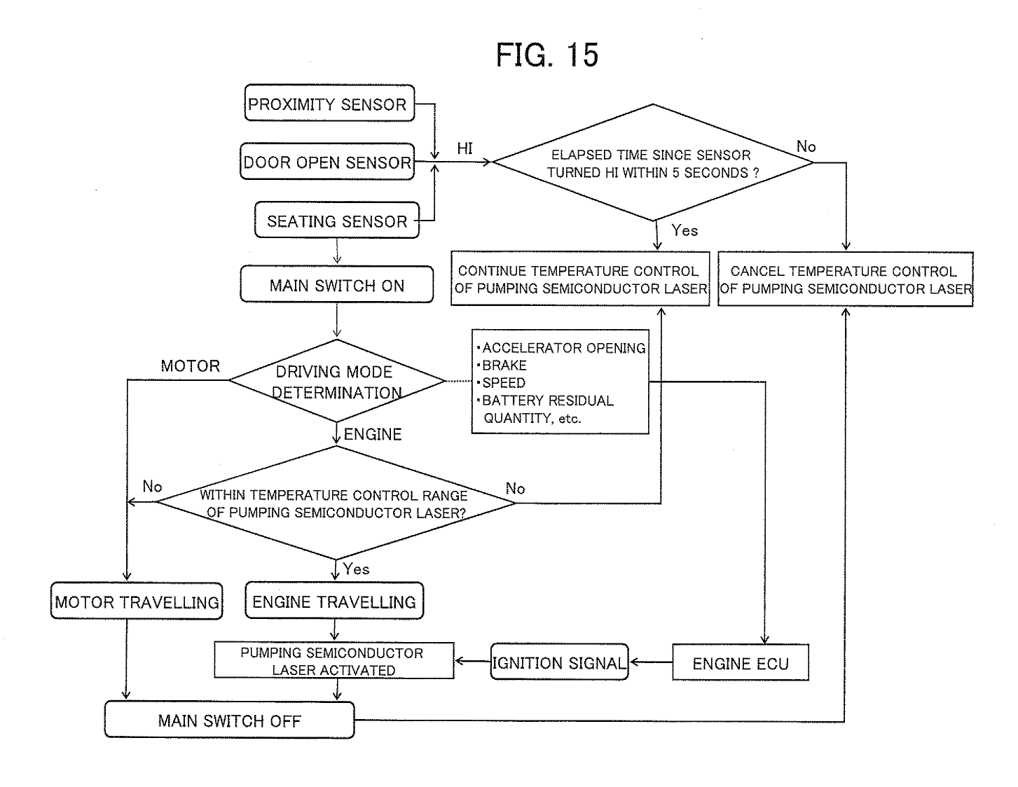

FIG. 15 shows specific procedure for controlling the semiconductor laser pumped solid-state laser device for engine ignition according to the present invention. Here, the description will concern the operation in a hybrid car that has been greatly prevailing in recent years.

As shown in FIG. 15, a hybrid car is configured to activate auxiliaries using signals from a proximity sensor that detects a driver carrying a smart key approaching the car, a door open sensor that detects a door on a driver's seat side being opened, and a seating sensor that detects a driver sitting on a driver's seat. There are also vehicles other than the hybrid cars which activate the auxiliaries using the sensors above. In the present invention, activation of the temperature control of the pumping semiconductor laser is controlled using the signals from the sensors above.

When any signal from the proximity sensor, the door open sensor, and the seating sensor turns to HI, the temperature control of the pumping semiconductor laser is initiated. The temperature control is continued if the elapsed time since the signal turned HI is within five seconds. If the elapsed time exceeds five seconds, it is determined that a main switch is not turned ON and the temperature control is cancelled. In a hybrid car, at the start of travelling, the vehicle may be driven either by an electric motor or an engine when a battery is less charged. When the main switch of a vehicle power source is turned ON, it is determined whether to drive the vehicle by the electric motor or the engine based on information on an accelerator opening, brake, speed, battery residual quantity, and the like. When driving by the engine, it is determined whether or not the temperature of the pumping semiconductor laser has reached a target temperature (temperature range in which the wavelength within the locking range can be emitted). If the temperature is off the target temperature, the mode is altered to a motor travelling mode while the temperature control is continued. If the temperature is within a target temperature range, the mode is set to an engine travelling mode and the pumping semiconductor laser is activated based on an ignition signal output from an engine control unit (ECU). When the main switch is turned OFF, the temperature control of the pumping semiconductor laser is cancelled.

In this regard, by using the semiconductor laser having high temperature response, the main switch of the vehicle power source and the temperature control unit of the pumping semiconductor laser are simultaneously turned ON to activate the temperature control of the semiconductor laser. Since the temperature of the semiconductor laser device is controlled to reach the temperature within a given locking range in two seconds, or five seconds at the latest, the oscillation wavelength of the semiconductor laser corresponds to the absorption wavelength of the solid-state laser, allowing the energy to be supplied to the solid-state laser module.

Here, in the case where the temperature control unit is kept ON regardless of the state of the main switch, the solid state laser can be pumped because the wavelength of the semiconductor laser remains within the locking range independent of the elapsed time since the main switch turned ON. However, the battery of the vehicle, even while parked, is consumed due to the power being consistently consumed by the temperature control unit. Here, the energy required for the temperature control can be reduced by using the heat insulator 300 having high heat insulation property and the heat sink 225 having high heat conductivity for locking the semiconductor laser, as shown in FIGS. 13 and 14.

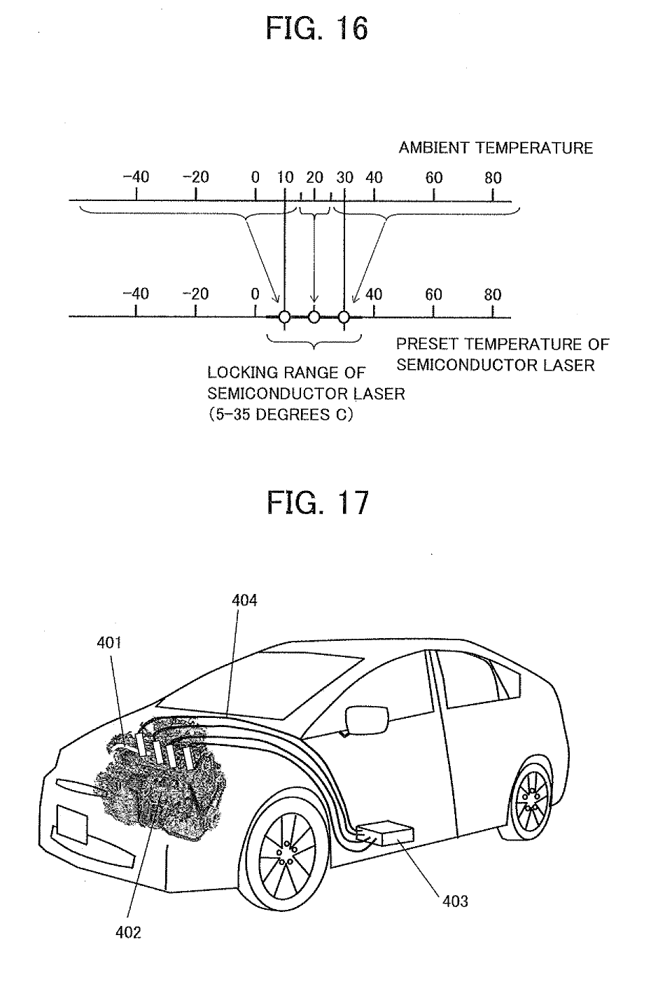

FIG. 16 shows a relationship between the ambient temperature of the semiconductor laser pumped solid-state laser device for engine ignition and a preset temperature of the semiconductor laser to be controlled, according to the present invention.

The controlled temperature of the semiconductor laser is not necessarily controlled consistently to a specific temperature, such as 20 degrees C., and it is desirable to be set to the temperature within the locking range proximate to the ambient temperature of a location where the semiconductor laser module is mounted. In this manner, the temperature of the semiconductor laser can be controlled more rapidly than being set to a uniform temperature, and the control power can be reduced because a temperature difference after the control with the ambient temperature is smaller. In FIG. 16, if the locking range of the wavelength stabilized semiconductor laser is between 5 and 35 degrees C. and the ambient temperature is lower than 15 degrees C., the controlled temperature of the semiconductor laser is set to 10 degrees C. as soon as the main switch of the vehicle is turned ON; if the ambient temperature is between 15 and 25 degrees C., the controlled temperature is set to 20 degrees C.; and if the ambient temperature is higher than 25 degrees C., the controlled temperature is set to 30 degrees C. By setting the controlled temperature of the semiconductor laser depending on the ambient temperature in this manner, the temperature of the semiconductor laser can be locked more rapidly within the locking range.

The present invention should not be limited to the embodiments described above, and a number of variations are possible on the basis of the spirit of the present invention. These variations should not be excluded from the scope of the present invention.

### INDUSTRIAL APPLICABILITY

The semiconductor laser pumped solid-state laser device for engine ignition according to the present invention can be utilized as the solid-state laser device for engine ignition that can stably supply the optical energy required for ignition across a wide temperature range.

What is claimed is:

1. A semiconductor laser pumped solid-state laser device for engine ignition wherein a plurality of semiconductor lasers are used that are locked within an absorption wavelength band of a solid-state laser medium, locking ranges thereof each having a different temperature range, and the overall locking range thereof completely covering a range of ambient temperature variation of the semiconductor lasers, to pump the solid-state laser medium by multiplexing emitted lights from the plurality of semiconductor lasers using a multiplexing mechanism to irradiate the solid-state laser medium.

2. The semiconductor laser pumped solid-state laser device for engine ignition according to claim 1, wherein the multiplexing mechanism is configured of an optical fiber.

3. The semiconductor laser pumped solid-state laser device for engine ignition according to claim 1, wherein the multiplexing mechanism is configured of a mirror.

4. The semiconductor laser pumped solid-state laser device for engine ignition according to claim 1, wherein the multiplexing mechanism is configured of a lens formed of an anisotropic metamaterial.

5. The semiconductor laser pumped solid-state laser device for engine ignition according to claim 1, wherein the wavelength of the semiconductor laser is stabilized using a grating.

6. The semiconductor laser pumped solid-state laser device for engine ignition according to claim 1, wherein the locking ranges of the respective semiconductor lasers are overlapped with each other.

7. A semiconductor laser pumped solid-state laser device for engine ignition provided with a temperature control mechanism for a semiconductor laser, wherein a plurality of preset temperatures are set within a locking range and a temperature control value is set to be one of the preset temperatures that most approximates an ambient temperature.

8. The semiconductor laser pumped solid-state laser device for engine ignition according to claim 7, wherein the temperature control of the semiconductor laser is activated when a driver approaches a vehicle, a door on a driver's seat side is opened, a person sits on a driver's seat, or a main switch of the vehicle is turned ON.

9. The semiconductor laser pumped solid-state laser device for engine ignition according to claim 7, wherein the semiconductor laser is enclosed by a heat insulator.

10. The semiconductor laser pumped solid-state laser device for engine ignition according to claim 1, wherein a temperature controlling element is disposed in a semiconductor laser module.

11. The semiconductor laser pumped solid-state laser device for engine ignition according to claim 10, wherein the temperature controlling element is a Peltier device.

12. The semiconductor laser pumped solid-state laser device for engine ignition according to claim 10, wherein a grating-embedded semiconductor laser device is disposed in the semiconductor laser module.

13. The semiconductor laser pumped solid-state laser device for engine ignition according to claim 1, wherein the plurality of semiconductor lasers are bonded to a member having high heat conductivity.
